(19) United States
(12) Patent Application Publication
(10) Pub. No.: US 2025/0213999 A1
(43) Pub. Date: Jul. 3, 2025

(54) EXTRACTION METHOD AND SYSTEM, AND RELATED COMPONENTS

(71) Applicants: David Ryan Crowe, Lake Forest Park, WA (US); Greg Shaw, Seattle, WA (US)

(72) Inventors: David Ryan Crowe, Lake Forest Park, WA (US); Greg Shaw, Seattle, WA (US)

(21) Appl. No.: 19/004,970

(22) Filed: Dec. 30, 2024

Related U.S. Application Data
(60) Provisional application No. 63/616,645, filed on Dec. 31, 2023.

(51) Int. Cl. B01D 11/02

(52) U.S. Cl. CPC B01D 11/0257

(57) ABSTRACT

An extraction method includes placing organic material in a first volume of a chamber of a system, wherein the chamber of the system is divided into the first volume and a second volume by a divider having a passage that allows fluid to move from the first volume into the second volume but does not allow organic material to move from the first volume into the second volume. The method then includes jostling the organic material, and capturing in the second volume the molecules released from the organic material.

### CROSS-REFERENCE TO RELATED APPLICATIONS AND INCORPORATION BY REFERENCE

This application claims priority from U.S. Provisional Patent Application 63/616,645 filed 31 Dec. 2023 and titled “Terpene Extractions Systems, and Related Methods”. This application also incorporates by this reference the entirety of this U.S. Provisional Patent Application.

### BACKGROUND

Organic material, such as plants, contain many different compounds and molecules that are desired for a variety of different reasons in many different industries such as food and beverage, cosmetics, nutraceuticals, and pharmaceuticals. For example, essential oils from one or more plants are often used to add flavor or aroma to a product such as lip balm, perfume, and/or candles. An essential oil is a concentrated hydrophobic liquid produced and contained in a plant. They contain volatile chemical compounds and molecules that give the specific plant it's unique aroma and taste, as well as other properties. Essential oils are typically extracted from a plant via steam distillation in which a plant is subjected to a steam bath to extract the oils out of the plant, and then the steam and dissolved essential oils are condensed to the liquid state and separated from each other. Another common process used to extract essential oils from a plant is solvent extraction in which the plant is immersed in a solvent to extract the oils out of the plant and then the solvent and dissolved essential oils are separated from each other by a variety of means, such as chromatography, distillation, and/or evaporation.

Unfortunately, these extraction processes do not provide a high yield from the plant because of the difficulty of extracting the oils from a plant via a steam bath, and the difficulty of separating the oils from the solvent via solvent extraction. During these processes the remaining organic material from which the compounds or molecules are extracted is often destroyed. This prevents the extraction of other compounds and molecules in the organic matter that one might also want. So, to get these other compounds and molecules, one has to extract these from a new, fresh batch of organic material. Another difficulty is that separating the oils from a solvent via chromatography can be expensive and require strict metrics to be able to isolate the desired compound or molecule.

Thus, there is a need for an extraction process that can extract different compounds and molecules from a single batch or source of organic matter, and that is quick and inexpensive.

### SUMMARY

In one aspect of the invention, a method for extracting molecules from organic material includes placing organic material in a first volume of a chamber of a system, wherein the chamber of the system is divided into the first volume and a second volume by a divider having a passage that allows fluid to move from the first volume into the second volume but does not allow organic material to move from the first volume into the second volume. The method then includes jostling the organic material, and capturing in the second volume the molecules released from the organic material.

By jostling the organic material while in the chamber, the organic material is encouraged to release volatile compounds and/or molecules from its fibers. After these compounds and/or molecules have been extracted from the organic material, one may then extract other compounds and/or molecules from the same organic material by a subsequent extraction process. In this manner, one can achieve higher yields of the many different desired compounds and/or molecules from the same source of organic material. For example, one can first extract terpenes from cannabis material, and then extract other compounds and/or molecules such as THC and/or other cannabinoids from the cannabis material. This method may also be used to extract ketones, esters, and other compounds and molecules from any organic material.

In another aspect of the invention, an extraction system includes a tank, a divider, and an agitator. The tank has a wall that defines a chamber, which has a volume, an entrance, and an exit. The divider is disposed in the chamber such that the divider divides the chamber's volume into a first volume and a second volume, and is operable to hold in the first volume organic material that contains molecules to be extracted from the organic material in the chamber. The divider includes a passage sized to allow a fluid to move from the first volume to the second volume while preventing the organic material from moving from the first volume to the second volume. The agitator is also disposed in the chamber and is operable to jostle the organic matter in the chamber's first volume while the compounds and/or molecules are extracted from the organic matter.

### BRIEF DESCRIPTION OF THE DRAWINGS

FIG. 1 shows a perspective view of a system, according to an embodiment of the invention.

FIG. 2 shows a cross-sectional view of the system shown in FIG. 1, according to an embodiment of the invention.

FIG. 3 shows a close-up, partial cross-sectional view of the system shown in FIGS. 1 and 2, according to an embodiment of the invention.

FIG. 4 shows a view of an agitator of the system shown in FIGS. 1-3, according to an embodiment of the invention.

FIG. 5 shows a perspective view of a divider of the system, according to another embodiment of the invention.

FIG. 6 shows a schematic view of an extraction method, according to an embodiment of the invention.

### DETAILED DESCRIPTION

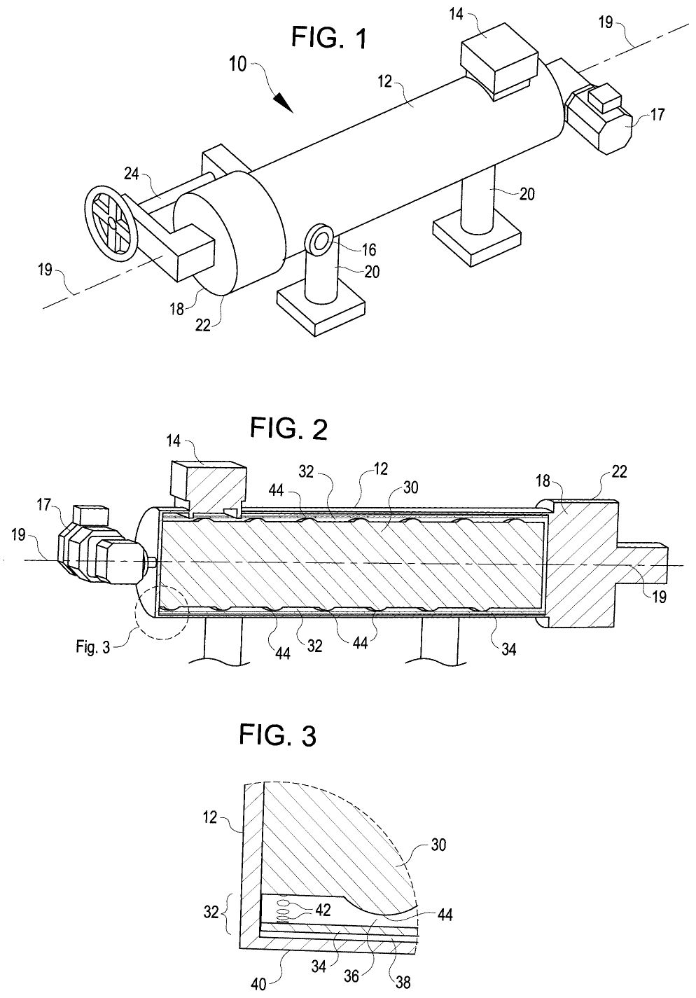

FIG. 1 shows a perspective view of a system 10, according to an embodiment of the invention. The system 10 extracts compounds and molecules from organic material without destroying the organic material. Here, for example, the system 10 is used to extract terpenes from cannabis, although the system 10 may be used to extract any compound and/or molecule from organic material. To do this, the system 10 includes a tank 12, a divider (shown and discussed in greater detail in conjunction with FIGS. 3, 4 and 5), and an agitator (also shown and discussed in greater detail in conjunction with FIGS. 2, 3 and 4). The tank 12 has a chamber that the divider divides into two volumes—a first volume and a second volume. Organic material enters the chamber through the entrance 14 and lies in the first volume. The agitator jostles the organic material to physically crack and/or break fibers of the organic material so that the volatile compounds and molecules can be released into the first volume of the tank's chamber. The compounds and/or molecules that have been separated from the fibers are then moved into the second volume through a screen of the divider that prevents the organic material from entering the second volume. The compounds and/or molecules are then removed from the second volume via the exit 16.

By jostling the organic material while in the first volume of the tank's chamber, the organic material is encouraged to release volatile compounds and/or molecules from its fibers. After these compounds and/or molecules have been extracted from the organic material, one may then extract other compounds and/or molecules from the same organic material by a subsequent extraction process. In this manner, one can achieve higher yields of the many different desired compounds and/or molecules from the same source of organic material. For example, here, one can first extract terpenes from cannabis material, and then extract other compounds and/or molecules such as THC and/or other cannabinoids from the cannabis material.

The system 10 also includes a mechanism to power the agitator. For example, in this and other embodiments, the system 10 includes an electric motor 17 that converts electrical energy into rotational energy that is output via a drive shaft. The drive shaft is coupled with the agitator such that the agitator rotates about an axis 19 of the tank 12 when electricity flows through the motor 17.

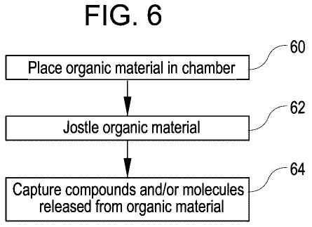

The system 10 may also include a heater and a pump to modify the environment inside the chamber. For example, the heater may be sized and configured to heat the chamber so that the temperature of the organic material inside the first volume can be raised to any desired temperature to facilitate the release of desired volatile compounds and/or molecules from the organic material. Similarly, the pump may be sized and configured to decrease the pressure inside the chamber to facilitate the release of desired volatile compounds and/or molecules from the organic material. When the heater and pump work together to facilitate the release of the compounds and molecules, particularly high yields may be achieved. As discussed in greater detail in conjunction with FIG. 6, the heater, the pump, or both may be controlled to provide a variety of different extraction atmospheres within the chamber. For example, the heater may be controlled to increase the temperature in the chamber for one or more periods during the extraction process followed by one or more periods in which the temperature decreases in the chamber. And similarly, the pump may be controlled to decrease the pressure in the chamber for one or periods during the extraction process followed by one or more periods in which the pressure increases in the chamber.

Still referring to FIG. 1, the system may also include a condenser to help separate the volatile compounds and molecules isolated in the second volume from the atmosphere in the second volume. The condenser essentially cools the atmosphere from the chamber's second volume that contains the desired volatile compounds and/or molecules in suspension. When cooled the volatile compounds and molecules suspended in the atmosphere coalesce to form droplets and even drops of liquid which fall out of suspension and into a catch where it is captured.

Still referring to FIG. 1, the system 10 also includes an exit 18 through which one may remove organic material after the extraction process is finished, and may also include a stand 20 to anchor the tank 12 to a floor or larger structure. In this and other embodiments, the exit 18 is closed by the cap 22 that is secured over the exit 18 by the screw 24. When closed, the cap 22 prevents air from outside the tank from entering the tank's chamber through the exit 18. In this and other embodiments, the system 10 includes two stands 20 that are configured to be secured to a floor.

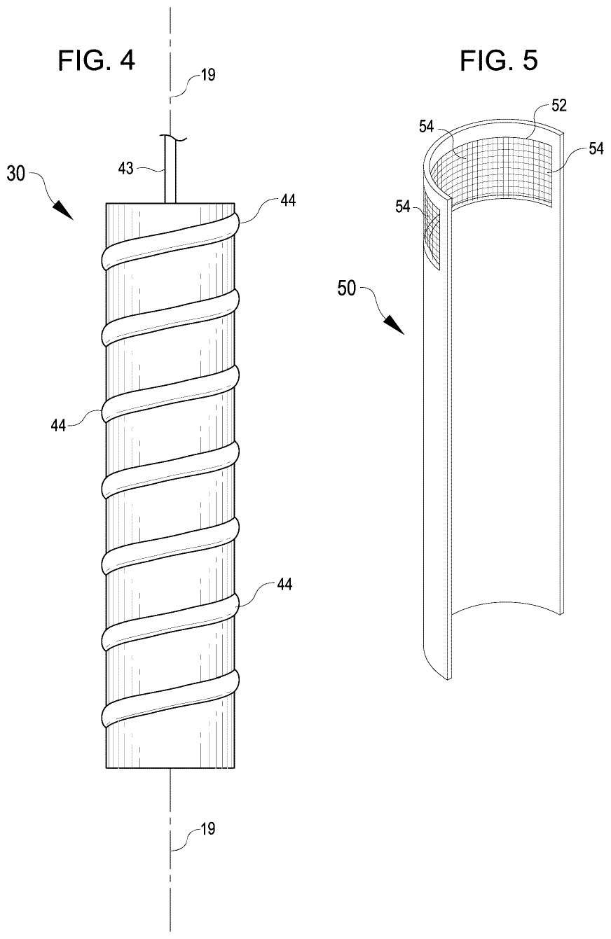

Each of FIGS. 2, and 3, shows a cross-sectional view of the system 10 shown in FIG. 1, according to an embodiment of the invention. FIG. 2 shows a cross-section of the whole tank 12 of the system 10; and FIG. 3 shows a close-up, partial cross-sectional view of the tank 12 of the system 10 shown in FIG. 1. FIG. 4 shows a view of an agitator 30 of the system 10, according to an embodiment of the invention. The agitator 30 jostles the organic material in the tank's chamber 32; and the divider 34 divides the chamber 32 into a first volume 36, and a second volume 38. The first volume 36 is the volume of the chamber 32 that lies between the agitator 30 and the divider 34. The second volume 38 is the volume of the chamber 32 that lies between divider 34 and the wall 40 of the tank 12. When the entrance 14 of the system 10 is open one may insert organic material into the first volume 36, and when the exit 16 is open one may remove from the second volume 38 compounds and molecules that have been separated from the organic material.

The divider 34 may be configured as desired to prevent organic material from entering the second volume 38 while compounds and/or molecules are released from the organic material and moved toward the exit 16. For example, in this and other embodiments the divider 34 includes a passage 42 (four shown in FIG. 4) that allow a fluid, such a terpene vapors, in the first volume 36 to flow into the second volume 38, and is configured to mimic the curvature of a portion of the chamber 32 along the axis 19 and sized to nest in the chamber 32 such that the chamber's second volume 38 includes the volume that lies between the divider 34 and the wall 40 of the tank 12. More specifically, the divider 34 mimics the shape of the tank 12 if the tank 12 were cut in half along the axis 19, and is sized to nest inside the chamber 32 in the tank 12 with an air-tight seal between the perimeter of the divider 34 and the region of the inside surface of the tank's wall 40 that lies directly across from the divider's perimeter.

Each of the passages 42 may be configured and located in the divider 34 as desired. For example, in this and other embodiments each of the passages 42 is oval in shape and sized to prevent organic material that is 0.5 millimeters (mm) and larger across from passing through and into the second volume 38. At this size, the passages 42 allow the terpene vapors from cannabis to easily pass through the passages 42 while preventing cannabis that has been reduced in size but not finely ground from passing through and entering the second volume 38. The passages 42 are all located at an end of the tank 12 where the organic material is most likely to be moved away from as the agitator jostles the material. This also helps prevent organic material from passing through the passages 42 and into the second volume 38.

The agitator 30 may be configured as desired to jostle the organic material that the divider 34 holds in the first volume 36 of the chamber 32. For example, in this and other embodiments the agitator 30 is cylindrical in shape and includes a drive shaft 43 that is couplable with the drive shaft of the motor 17 (FIGS. 1 and 2), and a lip 44. The lip 44 extends along the surface of the cylinder to form a spiral such that as the agitator 30 rotates about the axis 19 the lip appears to move along the axis 19. The agitator 30 is sized and positioned in the tank 12 such that a gap is formed (see FIG. 3) between the surface of the lip 44 and the surface of the divider 34 directly across from the lip 44. The distance of the gap is set so that organic material lying on the divider 34 in the first volume will not easily pass through gap so that when the lip 44 is moved over the organic material via the rotation of the agitator about the axis 19, the lip 44 will contact the organic material. Then, depending on the size and orientation of the organic material, the lip 44 will either push the material along the surface of the divider 34, or mildly crush the material. If the material is pushed along the surface it can collide with other organic material and or scrape along the surface, to crack or abrade fibers of the material. If the material is mildly crushed by the lip 44 the fibers of the material can be cracked.

FIG. 5 shows a perspective view of a divider 50 of the system 10, according to another embodiment of the invention. The divider 50 is similar to the divider 34 except that the divider 50 includes a screen 52 that has a plurality of passages 54 (only 3 labeled for clarity) that allow a fluid, such as volatile compounds and molecules, in the first volume 36 to flow into the second volume 38. The mesh size of the screen 52 may be any desired mesh size capable of preventing the designed size of organic material that results from the extraction process. For example, in this and other embodiments the mesh size of the screen 52 may range between 30 and 270. A mesh size of 30 means that each individual passage in the screen 52 is about 0.6 millimeters (mm) in size. A mesh size of 270 means that each individual passage in the screen 52 is about 0.053 mm. In this and other embodiments, the screen 52 consumes about an eighth of the total area of the divider 50; but in other embodiments the screen 52 may consume more of the total area of the divider 50 and may even equal the total area of the divider 50. In still other embodiments, the screen 52 may consume less than an eighth of the total area of the divider 50.

FIG. 6 shows a schematic view of an extraction method or process, according to an embodiment of the invention. The method or process includes an initial step 60 of placing organic material (here cannabis) into the chamber of the system's tank 12 (FIGS. 1 and 2). Then, at step 62, jostling the organic material. Then, at step 64, capturing the desired compounds and/or molecules (here terpenes) released from the organic material. This process may also be used to extract terpenes, ketones, esters, anthocyanins, chlorophyll and other compound and/or molecules from any desired organic material.

This process mitigates the loss and degradation of terpenes that occur throughout a typical extraction process that involves the use of a solvent. This process also allows one to remove terpenes from cannabis before other portions, such as THC and/or cannabinoids, of the cannabis are extracted. After the THC and/or cannabinoids are extracted, the removed terpenes may be mixed back into the THC and/or cannabinoids to provide a flavorful oil that may be vaped or consumed in some other manner.

Still referring to FIG. 5, In this and other embodiments, placing cannabis into the chamber includes simply pouring cannabis through the entrance 14 into the chamber 32. The amount poured in is determined by the desired depth of the cannabis layer on the divider 34, which is a little more than the gap between the divider 34 and the agitator's lip 44 that is set by the position of the agitator 30 in the chamber 32. In other embodiments, placing cannabis into the chamber 32 may include spreading cannabis evenly across the surface of the divider 34. The cannabis may be cured whole flower “bud” material or any grade of leaf material, such as, sugar leaves or fan leaves. Or, the cannabis may be uncured. Cured cannabis is cannabis that has been dried to remove some of the moisture from the cannabis.

In this and other embodiments, jostling the cannabis includes rotating the agitator 30 about the axis 19 (FIGS. 1 and 2) so that the agitator's lip 44 contacts the cannabis on the divider 34, for a period of time. In other embodiments jostling the cannabis may also include rotating the agitator 30 while the atmosphere inside the chamber 32 is heated and has a pressure that is less than the pressure of ambient air at sea level (about 760 Torrs). For example, the chamber's atmosphere 32, and thus the cannabis in the chamber 32, may be heated to a temperature within the range of 135° to 150° Celsius (C) while the pressure inside the oven is within the range of 740 Torrs to 1 mTorr (millitorr), for 45 to 120 minutes. The duration of the extraction process may be more, or less, depending on the pressure and temperature in the chamber 32. The warmer the temperature and the lower the pressure in the chamber, the quicker the duration or period for the extraction process.

In some embodiments of the jostling step, the heating of the atmosphere inside the chamber can ramp up and down to fluctuate during the jostling process. For example, the temperature may ramp up to 149° C. and then down to 65.5° C., in cycles. These cycles can be equal in duration or not, and the dwell period at the high and low temperatures within a cycle may be equal or not. Likewise, the pressure inside the chamber 32 may be ramped down and up to also fluctuate during the jostling process.

With fluctuations in the chamber pressure different terpenes may be extracted from cannabis during a single extraction process. For example, monoterpenes will be released from the cannabis first at lower pressure levels, then as the pressure drops further the sesquiterpenes and diterpenes start releasing from the cannabis.

Still referring to FIG. 5, in this and other embodiments, capturing the terpenes includes moving the released terpenes from the first volume 36 of the chamber 34 where the cannabis lies to the second volume 38 via the passages 42 in the divider 34. This may be done by allowing a small amount of air to flow through the first volume 36 and into the second volume 38. This then pushes the air in the second volume through the exit 16 (FIG. 1) and into a condenser having a second chamber. The temperature of the second chamber ranges between 15° C. and −80° C., so that the terpenes in the form of vapor coalesce into a liquid and fall into a trap where they can be collected.

Still referring to FIG. 5, in this and other embodiment, when the period for releasing the terpenes from the cannabis has ended, the pressure in the chamber 32 is brought back to atmospheric pressure and the temperature in the condenser's second chamber is warmed to room temperature. Subsequently, the released and captured terpenes can be collected, and the second chamber rinsed with distilled water to obtain terpene condensate remaining on the walls of the second chamber.

The preceding discussion is presented to enable a person skilled in the art to make and use the invention. Various modifications to the embodiments will be readily apparent to those skilled in the art, and the generic principles herein may be applied to other embodiments and applications without departing from the spirit and scope of the present invention. Thus, the present invention is not intended to be limited to the embodiments shown, but is to be accorded the widest scope consistent with the principles and features disclosed herein.

What is claimed is:

1. An extraction system, the system comprising:
a tank having a wall that defines a chamber having a volume, an entrance, and an exit;
a divider disposed in the chamber such that the divider divides the chamber's volume into a first volume and a second volume, and being operable to hold in the first volume organic material that contains molecules to be extracted from the organic material in the chamber, wherein the divider includes a passage sized to allow a fluid to move from the first volume to the second volume while preventing the organic material from moving from the first volume to the second volume; and
an agitator disposed in the chamber and operable to jostle the organic matter in the chamber's first volume while molecules are extracted from the organic matter.

2. The extraction system of claim 1 wherein the chamber is cylindrical in shape and has a longitudinal axis.

3. The extraction system of claim 1 wherein:
the chamber is cylindrical in shape and has a longitudinal axis, and
the divider is configured to mimic the curvature of a portion of the chamber along the longitudinal axis and sized to nest in the chamber such that the chamber's second volume includes the volume that lies between the divider and the wall of the tank.

4. The extraction system of claim 1 wherein:
the chamber is cylindrical in shape and has a longitudinal axis,
the divider is configured to mimic the curvature of a portion of the chamber along the longitudinal axis and sized to nest in the chamber such that the chamber's second volume includes the volume that lies between the divider and the wall of the tank,
the chamber's first volume includes the chamber's entrance, and
the chamber's second volume includes the chamber's exit.

5. The extraction system of claim 1 wherein the divider includes a screen having a mesh size between 30 and 270.

6. The extraction system of claim 1 wherein the agitator contacts the organic material to jostle the material in the chamber.

7. The extraction system of claim 1 wherein the agitator moves the organic material through the chamber's first volume while the agitator jostles the organic material.

8. The extraction system of claim 1 wherein the agitator includes a lip that contacts and jostles the organic material while the agitator rotates about a longitudinal axis.

9. The extraction system of claim 1 wherein:
the chamber is cylindrical in shape and has a longitudinal axis, and
the agitator includes a lip that contacts and jostles the organic material while the agitator rotates about the longitudinal axis.

10. The extraction system of claim 1 further comprising a second chamber coupled with the second volume of the first chamber operable to trap molecules extracted from the organic material.

11. The extraction system of claim 1 further comprising a heater operable to heat the first volume of the chamber.

12. The extraction system of claim 1 further comprising a pump operable to reduce the pressure inside the first volume of the chamber below atmospheric pressure.

13. A method for extracting molecules from organic material, the method comprising:
placing organic material in a first volume of a chamber of a system, wherein the chamber of the system is divided into a first volume and a second volume by a divider having a passage that allows fluid to move from the first volume into the second volume but does not allow organic material to move from the first volume into the second volume;
jostling the organic material; and
capturing in the second volume the molecules released from the organic material.

14. The method of claim 13 wherein jostling the organic material includes moving the organic material with a lip that extends as a spiral along the outside surface of a cylinder that rotates about a longitudinal axis of the chamber.

15. The method of claim 13 wherein jostling the organic material includes continuously moving the organic material with a lip that extends as a spiral along the outside surface of a cylinder that rotates about a longitudinal axis of the chamber, through the chamber's first volume.

16. The method of claim 13 wherein capturing the molecules released from the organic material includes urging the molecules into the chamber's second volume.

17. The method of claim 13 wherein capturing the molecules released from the organic material includes condensing in a second chamber the molecules into a liquid, wherein the second chamber is coupled with the second volume of the chamber.

18. The method of claim 13 further comprising heating the organic material in the chamber's first volume.

19. The method of claim 13 further comprising reducing the pressure inside the chamber's first volume below atmospheric pressure.
